(19) United States
(12) Patent Application Publication
(10) Pub. No.: US 2007/0047478 A1
(43) Pub. Date: Mar. 1, 2007

(54) Method for access assurance in a wireless communication system

(75) Inventors: Krishna Balachandran, Morganville, NJ (US); Kenneth C. Budka, Marlboro, NJ (US); Joseph H. Kang, Belle Mead, NJ (US)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/214,492

(22) Filed: Aug. 30, 2005

(51) Int. Cl. H04Q 7/00

(52) U.S. Cl. 370/328

(57) ABSTRACT

A method for access assurance in a wireless communication system, e.g., a mobile phone network, involves allocating communication resources for transactions between the network and various wireless access terminals (each having a unique identifier) based on priority classes assigned to the access terminals. The access terminals are divided into different priority classes based on public policy and similar considerations. Each access terminal's priority class is associated with its identifier in a database. Upon communicating with an access terminal, the network determines the access terminal's priority class based upon its identifier as received by the network, e.g., the identifier is correlated to the priority class in the database. Transaction priority levels are then calculated based on each access terminal's priority class. Air interface resources are allocated according to the computed transaction priority levels and one or more pre-determined allocation precedence rules governing priority.

### FIELD OF THE INVENTION

The present invention relates to communications and, more particularly, to wireless communication systems.

### BACKGROUND OF THE INVENTION

Various advances in commercial wireless and networking technologies have enabled the support of voice and high-speed data services to wireless-device end users, e.g., those using mobile phones, wireless personal digital assistants (PDA's), or the like. As third generation wireless packet data networks evolve to support a wide range of unicast and broadcast/multicast multimedia services, one of the major challenges faced is to provide quality of service (“QoS”) differentiation across different classes of users and/or services.

Recently, there has been significant interest in leveraging advances in commercial wireless networking technology to also support public safety wireless communications, e.g., “mission critical” and administrative communications for federal, state and local law enforcement agencies, fire departments, and emergency medical personnel. In tactical law enforcement and first responder scenarios, there are a number of unique mission critical service requirements where access assurance becomes particularly important. This is because these services, in contrast to commercial, revenue-generating services, involve public safety issues including the possible loss of life. For example: (i) a “man down alert” where a dispatcher is alerted that a law enforcement official may have been seriously injured during an operation; (ii) “silent emergency” messages where an access terminal is used to inform a dispatcher of a hostage situation; (iii) “discreet listening” where a dispatcher may establish a call to a public safety access terminal for listening in without any end user intervention; (iv) a push-to-talk floor control request to say “Officer down,” “Get out of the building,” or “Stop, don't shoot!”; and/or (v) a state of emergency declaration in a disaster scenario where preferential access must be made available to on-scene public safety personnel. Thus, when mission critical services are invoked, a stringent end-to-end delay requirement will typically need to be met, one that is independent of the prevailing load from non-mission critical services, e.g., commercial or general public wireless device use.

In wireless communication networks, on account of air interface and backhaul resource constraints (“backhaul” typically refers to the signal transfer from a base station transceiver to a base station controller), the radio access portion of the network is typically more of a bottleneck than the core/landline portion of the network. From a radio access network resource allocation perspective, mission critical services are preferably given pre-emptive priority over other, non-mission critical services in order to ensure that the former obtain preferential access to scarce resources, especially over the radio interface.

### SUMMARY OF THE INVENTION

An embodiment of the present invention relates to a method of communicating over a wireless communication system, such as a wireless device network or the like. For the purposes of the present disclosure, access terminals shall include mobile phones, wireless PDA's, wireless devices with high-speed data transfer capabilities, such as those compliant with “3-G” or “4-G” standards, for example, “WiFI”-equipped computer terminals, and the like. Typically, each access terminal may have an existing, unique identifier for communications over the wireless network. In carrying out the method, each access terminal may be assigned one or more priority classes. Upon communicating with an access terminal, the network determines at least one of the access terminal's priority classes based upon its identifier as received by the network. Subsequently, network communication resources are allocated to the access terminals based on their priority classes.

In another embodiment, for transmissions between the access terminals and wireless network, the wireless network determines transaction priority levels based on the access terminals' respective priority classes. The wireless network then allocates communications resources according to the transaction priority levels. According to an additional embodiment, this may include applying one or more pre-determined allocation precedence rules governing priority.

In another embodiment, the wireless network may determine different transaction priority levels for forward and reverse link transactions. Optionally, the determination of transaction priority levels may be based on information in addition to the priority classes, such as messages received from the access terminals containing requested priority levels.

### BRIEF DESCRIPTION OF THE DRAWINGS

The present invention will be better understood from reading the following description of non-limiting embodiments, with reference to the attached drawings, wherein below:

FIG. 1 is a schematic diagram of a wireless communication system according to an embodiment of the present invention;

FIG. 2 is a schematic diagram of an authentication, authorization, and accounting module;

FIG. 3 is a flowchart showing the steps of a method for access assurance according to an embodiment of the present invention;

FIG. 4 is a schematic diagram of a protocol stack;

FIG. 5 is a schematic timing diagram of communications between an access terminal and radio access network; and

FIG. 6 is a schematic diagram of forward and reverse link transaction priority levels.

### DETAILED DESCRIPTION

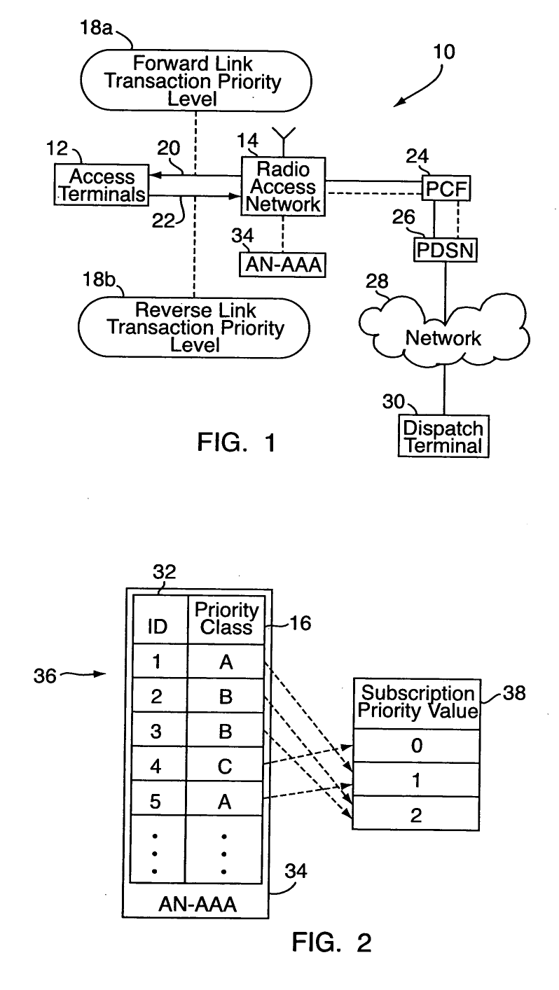

With reference to FIGS. 1-6, an embodiment of the present invention relates to a method for access assurance in a wireless communication system 10, e.g., a mobile phone network or the like. “Access assurance” refers to procedures, typically carried out automatically by the wireless communication system, for assuring that certain end users having a critical need to communicate are able to do so in a timely manner. The wireless communication system 10 includes a number of distributed mobile phones and other wireless devices 12 (referred to collectively as “access terminals”) in communication with a radio access network 14. For access assurance, the access terminals 12 are segregated into different priority classes 16, e.g., “A,” “B”, “C,” and so on. Typically, this will be done on a device-by-device basis, based on public policy and similar considerations. For example, access terminals for use by high-ranking public-safety officials might be assigned to class A, access terminals for use by other public safety personnel to class B, and public or commercial access terminals to class C.

For transmissions between the access terminals 12 and radio access network 14, the radio access network 14 computes or otherwise determines a transaction priority level 18a, 18b for each access terminal 12 based on that access terminal's pre-designated priority class 16. In other words, the radio access network associates a respective priority level with each transaction (meaning data signals or other communications) between it and each of the access terminals 12. The transaction priority level is a measure or metric of the extent to which each access terminal is authorized for preemptive or priority transmissions over the radio access network, relative to the other access terminals using the network. Optionally, for each access terminal 12, the radio access network 14 determines a forward link transaction priority level 18a for transactions across the forward link 20 from the radio access network 14 to the access terminal 12, and a reverse link transaction priority level 18b for transactions across the reverse link 22 from the access terminal 12 to the radio access network 14.

The radio access network 14 then allocates air interface and possibly other communication resources according to the computed transaction priority levels 18a, 18b for all the access terminals 12 and one or more pre-determined allocation precedence rules governing priority. One allocation precedence rule might be that transactions having a higher associated transaction priority level are transmitted before those having a lower associated transaction priority level. This allows the radio access network 14 to preferentially allocate resources as needed in both directions (forward link and reverse link) for mission critical transactions.

The radio access network 14 includes one or more fixed base stations each with various transceivers and antennae for radio communications with the access terminals 12. The base stations are in turn connected to one or more base station or other controllers, which act as the interface between the wireless/radio end of the communication network 10 and the rest of the network 10, including performing the signaling functions necessary to establish calls and other data transfer to and from the access terminals 12. (The base stations and controllers are shown collectively as the “radio access network” 14 in FIG. 1.)

For wireless transmissions, the radio access network 14 may utilize a CDMA (code division multiple access) spread-spectrum multiplexing scheme. In CDMA-based networks, transmissions from the access terminals 12 to the base stations are across a single frequency bandwidth known as the reverse link 22, e.g., a 1.25 MHz bandwidth centered at a first designated frequency. Generally, each access terminal is allocated the entire bandwidth all of the time, with the signals from individual access terminals being differentiated from one another using an encoding scheme. Transmissions from the base stations to the access terminals 12 are across a similar frequency bandwidth (e.g., 1.25 MHz centered at a second designated frequency) known as the forward link 20. The forward and reverse links may each comprise a number of traffic channels and signaling or control channels, the former primarily for carrying data, and the latter primarily for carrying the control, synchronization, and other signals required for implementing CDMA communications. The radio access network 14 may be geographically divided into contiguous cells, each serviced by a base station, and/or into sectors, which are portions of a cell typically serviced by different antennae/transceivers supported on a single base station.

The radio access network 14 may be a CDMA2000® (IS-2000) high rate packet data (“HRPD”) network. CDMA2000® is a “3-G” (third generation) mobile telecommunications protocol/specification configured for the high-speed wireless transmission of both voice and non-voice data using IP (Internet Protocol) data packets or the like, including BCMCS. If so, the communication system 10 will also include a packet control function 24 (“PCF”) and a packet data serving node 26 (“PDSN”). The PCF 24 manages the relay of data packets between the radio access network 14 (specifically, the base station controller) and the PDSN 26, and is usually part of the base station controller equipment. The PDSN 26 serves as a gateway to an IP-based core network 28, allowing for the transfer of data to and from the radio access network 14 over the network 28. This functionality is used for communications between the access terminals 12 and remote access terminals connected to the network 28, such as a dispatch terminal 30 having IP connectivity.

Access assurance requirements for mission critical public safety communications or the like apply regardless of whether the radio-frequency spectrum in question is dedicated for public safety communications or whether it is shared between public safety users and other users. As long as the communication system and radio resources are shared by users engaging in mission critical and non-mission critical communications, mechanisms that help to provide a higher priority for mission critical communications are beneficial. Generally speaking, access assurance for radio interfaces can be based on one or more of the following: (i) contention access procedures that allow for shorter access delay times and/or for a higher probability of success for high priority or mission critical transaction access attempts; (ii) identification of the user and an associated transaction priority level so that preferential treatment can be provided for data and signaling associated with the transaction in both directions (including possible prioritization over the air interface and prioritization across backhaul segments of the radio access network; and (iii) resource allocation and scheduling mechanisms on the radio access network for preferential treatment of higher priority data. The present invention primarily relates to the second component, namely, identification of the user/access terminal and an associated transaction priority level, with the primary objective being to prioritize resource allocation over the air interface.

The method for access assurance of the present invention utilizes multiple preemptive transaction priority levels that are transaction based and that are based on the identity of the end point, e.g., end user and/or access terminal. It also offers support for different priority levels for different applications (short messages, push-to-talk, etc.), as well as priority on both the forward link and reverse link, as applicable to the service. Further, there is a minimal impact on non-mission critical (e.g., commercial) users and on the network operator when sharing resources with users engaging in mission critical transactions.

Access in wireless packet data systems is typically characterized by the use of different identifiers at various protocol layers to represent the access terminal and/or the user. These identifiers may either be permanent identifiers assigned by the manufacturer or network service provider, or temporary identifiers assigned by a protocol layer for a certain period of time. For example, the access terminal 12 may be assigned a permanent mobile node identity (“MN ID”) in the form of an electronic serial number (“ESN”) or international mobile station identity (“IMSI”). For systems that use the point-to-point protocol (“PPP”) for link establishment, the network access identifier (“NAI”) is typically used to identify the access terminal. One or more of these identifiers are often employed for the purpose of device authentication, authorization and accounting. In addition, different temporary access terminal identifiers may be used for various reasons. For example, an IP address may be used to identify the access terminal for wide area networking. Temporary identifiers might also be used to identify access terminals having a packet data session established with the radio access network 14, or to identify access terminals at the medium access control (“MAC”) layer in order to indicate the transmitter or intended recipient of data on the air interface. Temporary identifiers for the latter are typically smaller identifiers (e.g., use fewer bits) in order to reduce the resulting overhead on the air interface. Identifiers are also used to identify users that have been authenticated, for example, through the use of a password or biometric data. Such identification is useful in cases where multiple users may share a user device, and the set of allowable access priorities is determined by a user's identity rather than the identity of the access device. These identifiers are typically session layer tokens that have been assigned to the user upon successful authentication.

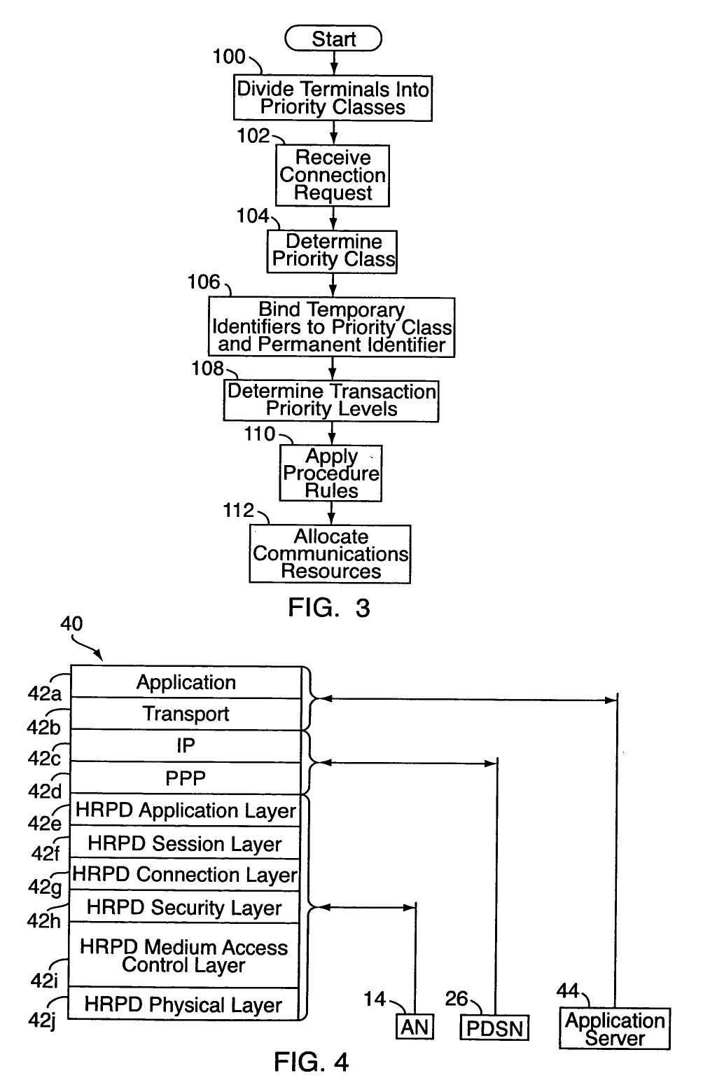

Access assurance according to the present invention will now be discussed in further detail with reference to FIGS. 1-3. At Step 100 in FIG. 3, the access terminals 12 are segregated into a number of access terminal priority classes 16. Optionally, the access terminals may be assigned priority classes based on the context in which they will be used, in light of public policy considerations. For example, access terminals used for law enforcement agencies, commercial enterprises, and casual end users may all belong to different priority classes, e.g., classes A-C as indicated in FIG. 2. As noted above, this will typically be done on a device-by-device basis. Each access terminal's permanent identity 32 (e.g. IMSI, NAI) maps in a one-to-one manner to the access terminal's priority class 16. The pre-determined mapping of permanent identity 32 to access terminal priority class 16 may be stored in an access network authentication, authorization, and accounting module 34 (“AN-AAA”), as part of a profile 36 for the access terminal 12.

In the case of an access terminal-originated transaction, the access terminal 12 typically requests a connection to the access network 14 using contention access procedures. The connection request is used to request allocation of radio resources for the transfer of data, i.e., it initiates the process to establish a traffic channel for data transfer. The connection request is typically encapsulated in a medium access control protocol data unit (“MAC PDU”) on the access channel; it may also be possible to piggyback small amounts of data within the access channel MAC PDU. The access channel MAC PDU also includes one or more of the above identifiers (either temporary or permanent) in order to identify the access terminal in question.

Upon receipt of the MAC PDU by the radio access network 14 at Step 102 (or upon a connection being initiated in another manner), the radio access network 14 proceeds with device authentication. Upon successful device authentication, the radio access network 14 determines the priority class 16 associated with the access terminal 12 by mapping the permanent identity 32 of the access terminal 12 to the priority class 16 in, e.g., the AN-AAA 34, at Step 104. At Step 106, the radio access network 14 binds any temporary identifiers that are used for the packet data session to the permanent identity 32 and to the access terminal priority class 16. A similar binding is also carried out upon assignment of any temporary identifiers by the MAC layer during periods of active data transfer. The binding of permanent and temporary identities already occurs implicitly in 3-G cellular networks when binding connections across different radio access network segments. Also binding the access terminal priority class 16 ensures that each transferred PDU may be appropriately prioritized over the air interface (for the forward link) and over the air interface and backhaul (for the reverse link).

At Step 108, the radio access network 14 calculates or otherwise determines the transaction priority level(s) 18a, 18b for use in prioritizing transactions between it and the access terminal 12, based on the priority class 16. This is done for each access terminal 12 in communication with the radio access network 14. At Step 110, the radio access network 14 applies the pre-determined precedence rules to the transaction priority levels 18a, 18b. Then, at Step 112, based on the transaction priority levels and precedence rules, the radio access network 14 allocates communications resources between the various access terminals 12 in communication with the radio access network 14. In other words, the radio access network 14 determines transaction priority levels for each access terminal in communication, and then allocates airlink communication resources among the various access terminals based on the transaction priority levels, e.g., according to the precedence rules as applied to the transaction priority levels.

The determination of transaction priority level(s) for an access terminal 12 is generally based on the access terminal's associated priority class 16. Thus, the transaction priority level 18a, 18b may be a direct function of the priority class 16: transaction priority level=f (priority class). Alternatively, each access terminal priority class 16 may be associated with a subscription priority value 38, with the transaction priority level 18a, 18b being specified as a function of the subscription priority value 38: transaction priority level=f (subscription priority value). Subscription priority values are useful for mathematical calculations when the priority classes 16 are termed in a colloquial sense, e.g., a “high” priority class, “mid” priority class, and “low” priority class.

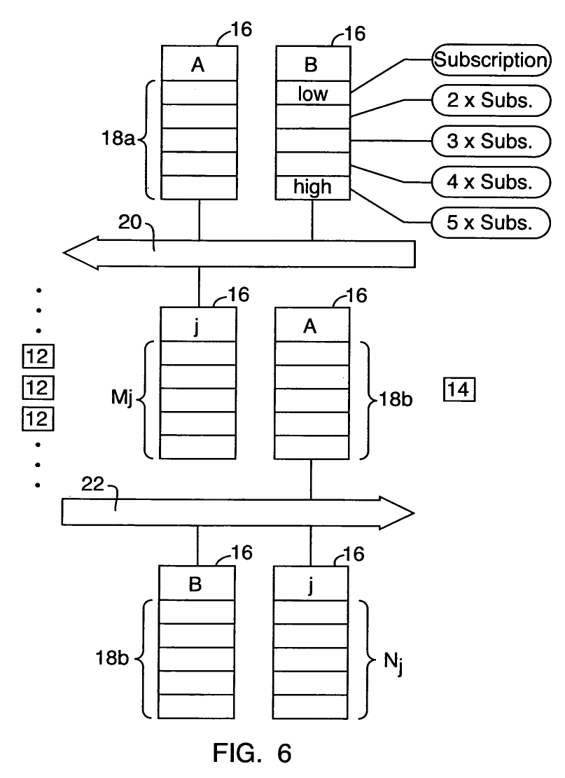

As noted, for each priority class 16, there may be one transaction priority level 18a for transactions across the forward link 20, and another 18b for the reverse link 22. Alternatively, there may be a discreet number of priority levels for each priority class 16 for each link 20, 22. In such a case, each data transaction associated a particular priority class “j” is assigned one of Mⱼ priority levels for the forward link and one of Nⱼ priority levels on the reverse link (see FIG. 6). In one embodiment of the invention, the number of possible forward and reverse link priority levels 18a, 18b associated with a priority class 16 may be identical. The actual priority levels assigned to transactions in both directions may be the same or different.

According to another embodiment of the present invention, the radio access network 14 may base its determination of the transaction priority levels 18a, 18b in whole or in part upon the type of access terminal application (e.g., software program) seeking to communicate, and/or upon information contained in connection requests received from the access terminals. For example, an access terminal connection request may include a transaction priority level that the radio access network 14 treats as either a “hard” command or a request. (Typically, they will be treated as requests since command-like functionality can be factored into the precedence rules, i.e., it is possible to ensure that certain requests will always be granted based on the precedence rules.) Thus, the corresponding forward and reverse link priority levels of the transaction may be included within the connection request, e.g., one of Mⱼ forward link priority levels and Nⱼ reverse link priority levels if the access terminal belongs to class “j.” For example, a push-to-talk floor request may be associated with the highest priority level for a law enforcement access terminal priority class in both directions. In cases where the priority levels assigned to the transaction are the same, it suffices to indicate a single priority level within the initial access request.

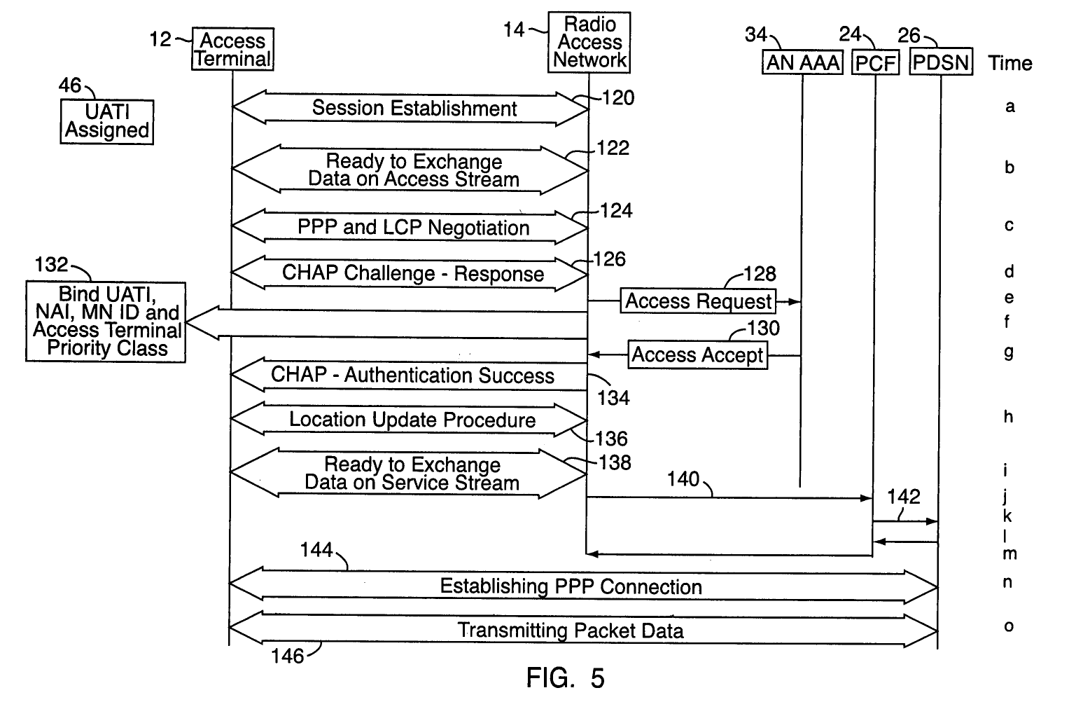

With reference to FIGS. 1, 4, and 5 in particular, the access assurance method of the present invention will now be further discussed with respect to its implementation in a wireless communication system 10 having a CDMA2000® type HRPD radio access network 14. FIG. 1 shows the logical network elements within the communication system 10, and FIG. 5 illustrates the call flow for an access terminal-initiated data transfer, e.g., access terminal origination when there is no previously established session. FIG. 4 shows a corresponding HRPD protocol stack 40. The protocol stack 40 may include an application layer 42a, a transport layer 42b (both as relating to interfacing with an application server 44 on the network 28 or otherwise), the IP and PPP layers 42c, 42d, an HRPD application layer 42e, an HRPD session layer 42f, an HRPD connection layer 42g, an HRPD security layer 42h, an HRPD MAC layer 42i, and an HRPD physical layer 42j.

First, at Step 120 in FIG. 5, the access terminal 12 establishes a session with the radio access network 14. As a part of this procedure, the protocols and protocol configurations to be used are negotiated, stored, and subsequently used for communications between these entities. The session establishment procedure also results in the assignment of a temporary unicast access terminal identifier 46 (“UATI”) to the access terminal 12. The assigned UATI is subsequently included in every access channel MAC header. (Prior to UATI assignment, the access terminal 12 selects a random UATI for inclusion in the access channel MAC header.) Once the access terminal 12 is ready to exchange data on the access stream, as at Step 122, the access terminal 12 and radio access network 14 initiate PPP and LCP (link control protocol) negotiations for access authentication, at Step 124. At Step 126, device access authentication is performed using the challenge handshake authentication protocol (“CHAP”). The radio access network 14 generates a random challenge and sends it to the access terminal 12. When the radio access network 14 receives a CHAP response message back from the access terminal 12, it sends an access request message containing the NAI identifier and the CHAP password to the AN-AAA 34, at Step 128. The AN-AAA 34, which acts as a remote authentication dial-in user service (“RADIUS”) server, looks up a password based on a user-name attribute in the access request message. If the access authentication passes, at Step 130 the AN-AAA 34 sends an access-accept message back to the radio access network 14. The access-accept message contains a RADIUS callback identifier set to the MN ID 32 (e.g., IMSI) of the access terminal 12. The AN-AAA 34 may also indicate the access terminal priority class 16 to the radio access network 14 in addition to the MN ID 32, as part of the access-accept message or otherwise. This enables the radio access network 14 to determine the priority class (as at Step 104 in FIG. 3), and in turn implies a subscription priority value 38 to be used for the access terminal.

At Step 132 (Step 106 in FIG. 3), the radio access network 14 subsequently binds the UATI, NAI, MN ID, and access terminal priority class 16 (or subscription priority value 38) for providing the appropriate priority treatment during subsequent data transfer. Alternatively, if the radio access network 14 has the mapping between the MN ID 32 and access terminal priority class 16 previously stored, it can just determine the access terminal priority class 16 and/or subscription priority value 38 through a table look-up. At Step 134, the radio access network 14 may send a CHAP authentication success message to the access terminal 12, and there may be a location update procedure at Step 136. The access terminal is now ready to exchange data on the service stream, as indicated at Step 138. The radio access network 14 then establishes a connection with the PCF 24 at Step 140, which in turn establishes a connection with the PDSN 26 at Step 142. (As mentioned, the PDSN 26 serves as a gateway to an IP based core network 28.) Once these connections are established, a PPP connection 144 may be established between the access terminal 12 and the PDSN for data transfer 146.

The wireless 12 device typically requests a traffic channel for data transfer by sending a connection request (e.g., connection layer message) encapsulated within an access channel MAC layer 42i capsule. (Note that the MAC layer header contains the UATI.) The connection request message contains a four-bit “request reason” field which is encoded as follows:

0x00: access terminal initiated

0x01: radio access network initiated

all other values invalid

The request reason field may also be used to denote requested transaction priority levels 18a, 18b. Here, the access terminal transmits the requested transaction priority level to the wireless network, and then transmits data (e.g., voice data) to the wireless network 14 according to the communications resources allocated by the wireless network, which are based on the requested transaction priority level and/or the access terminal's assigned priority class. Up to fourteen requested transaction priority levels may be indicated; however, a smaller number of priority levels (say five for example) will typically suffice. For example, in the case where there are five transaction priority levels and a single priority level is used for both the forward and reverse link, the request reason field may be encoded as follows:

0x00: access terminal initiated, priority level=subscription priority

0x01: radio access network initiated

0x02: access terminal initiated, priority level=2·subscription priority

0x03: access terminal initiated, priority level=3·subscription priority

0x04: access terminal initiated, priority level=4·subscription priority

0x05: access terminal initiated, priority level=5·subscription priority

all other values invalid

Here, the subscription priority 38 is a unique value determined according to the access terminal's priority class 16. Also, as should be appreciated, the requested priority level included in the request reason field may be a function of the type of communication being sent and/or the type of application on the access terminal 12 seeking to send a communication. For example, a text messaging transmission might be considered as low priority (0x00 field), while a push-to-talk transmission might be considered as high priority (0x05 field).

The radio access network 14 may accept the connection request by responding with a traffic channel assignment message. The inclusion of a four-bit priority field in the traffic channel assignment message allows the radio access network 14 to either accept the requested priority or to assign a new transaction priority. A new “TRANS_PRI_ACC” flag included within the traffic channel assignment message is set to “0” to accept the requested priority. However, if the flag is set to “1,” the access terminal 12 is required to read another four-bit flag, referred to as “UPDATED_PRIORITY.” In the above exemplary embodiment with five priority levels per access terminal priority class, this four-bit UPDATED_PRIORITY flag may be encoded as follows:

0x00: priority level=subscription priority

0x01: priority level=2·subscription priority

0x02: priority level=3·subscription priority

0x03: priority level=4·subscription priority

0x04: priority level=5·subscription priority

all other values invalid

Although the example shows the transaction priority level as an integer multiple of the access terminal's subscription priority, any function of the subscription priority value can be used in general.

The radio access network binds the MAC index included in the traffic channel assignment message to the UATI 46 and MN ID 32 of the access terminal 12, which in turn implies a binding to the transaction priority level 18a, 18b. Priority precedence rules that apply across the transaction priority levels for all access terminals are then used to preferentially schedule data over the air interface. One exemplary embodiment of a priority precedence rule is to always allow a transaction with higher priority to preempt a transaction with lower priority.

FIG. 6 is a graphical representation of one possible transaction priority level structure according to the present invention, for the forward link 20 and reverse link 22. As indicated, access terminals 12 are divided into three priority classes 16: “A” (highest priority, e.g., public safety command); “B” (medium priority, e.g., regular public safety); and “j” (low priority, e.g., commercial). Upon an access terminal 12 initiating a transaction with the radio access network 14, transaction priority levels 18a, 18b for transactions across the forward and reverse links are determined. In the broadest sense, the determination may be based on the access terminal's priority class 16 as determined from the access terminal's ID 32. In such a case, there would be one transaction priority level for priority class A, one for class B, and one for class j. The radio access network 14 would then allocate resources based on the transaction priority levels. This might be done by applying one or more precedence rules to the transaction priority levels, such as “A before B before j.” The determination of transaction priority levels might also be based on the priority class 16 plus additional information such as requested transaction priority levels received from the access terminals 12. For example, the radio access network 14 might receive a “0x00” request from a priority class A access terminal, and a “0x05” request from a priority class B access terminal, the former representing, e.g., a text message from a fire chief, and the latter representing, e.g., a push-to-talk floor request from a police officer. The radio access network 14 would then determine the transaction priority level for each, based on the priority class and request, and allocate resources accordingly by applying the precedence rules to the transaction priority levels. For example, it might be the case that a “0x05” request from a class B access terminal would take precedence over a “0x00” request from a class A access terminal.

As should be appreciated, the subscription priority values provide a means for the user to signal transaction priorities, e.g., in the connection request message. There are several ways this can be accomplished. For example, as described above, each access terminal's identifier may map to a priority class, with the priority class mapping to a subscription value (e.g., a one-to-one mapping). The access terminal/user indicates a requested transaction priority that may be based on a multiplicative factor (or other mathematical factor) of the subscription priority value. Alternatively, the access terminal identifiers may map to various priority classes, with each priority class having a list of eligible transaction priority levels, e.g., ordered from least priority P₁ to highest priority Pₙ. When the access terminal indicates a requested transaction priority, it is indicating which offset into that priority sequence it is requesting.

The radio access network 14 may modify the transaction priority at any time during the transaction. The transaction priority no longer remains valid when resources are released, e.g., when the inactivity timer expires and the traffic channel is torn down. The transaction priority mechanisms of the present invention are applicable to both circuit mode and packet mode transactions since similar procedures are used in both cases to admit the transaction on the air interface, e.g., through a traffic channel assignment.

Instead of or in addition to segregating access terminals into priority classes, the end users may be segregated into access priority classes with a one-to-one mapping between the user's priority class and the permanent identity 32 (e.g., IMSI, NAI) of the device 12 with which the user is accessing the network 14. In this case, each user priority class is associated with a subscription priority value. User-level authentication parameters (e.g., passwords, biometric data) may be stored in the AN-AAA 34. (Note that the end user and access terminal are viewed interchangeably from the perspective of access assurance.)

Since certain changes may be made in the above-described method for access assurance in a wireless communication system, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method of communicating over a network with a plurality of wireless access terminals each having at least one identifier, the method comprising the steps of:
determining at least one priority class for each access terminal based on the access terminal's at least one identifier; and
allocating resources for transactions between the network and access terminals based on the priority classes.

2. The method of claim 1 wherein the step of allocating resources comprises the sub-steps of:
determining transaction priority levels for the access terminals based on their respective priority classes; and
allocating the resources for transactions between the network and access terminals based on the transaction priority levels.

3. The method of claim 2 wherein:
the resources are allocated based on at least one allocation precedence rule as applied to the transaction priority levels.

4. The method of claim 2 wherein:
the network has forward and reverse communications links;
the transaction priority levels comprise, for each access terminal, at least first and second transaction priority levels for transactions across the forward and reverse links, respectively; and
the step of allocating resources comprises allocating forward and reverse link communication resources based on the at least first and second transaction priority levels, respectively.

5. The method of claim 4 wherein:
the method further comprises the step of receiving requested priorities from the access terminals; and
the transaction priority levels are calculated based on the requested priorities and priority classes.

6. The method of claim 1 wherein:
the method further comprises the step of receiving requested priorities from the access terminals; and
the resources are allocated based on the priority classes and requested priorities.

7. The method of claim 1 further comprising the step of:
determining the identifiers from one or more communication protocol layers in place on the network.

8. The method of claim 1 wherein:
the method further comprises the steps of, for each access terminal and prior to the step of determining the at least one priority class:
assigning the at least one priority class to the access terminal; and
associating the at least one priority class with the at least one identifier in a database; and
the step of determining the at least one priority class for each access terminal comprises the sub-steps of:
receiving the at least one identifier from the access terminal; and
correlating the at least one identifier to the at least one priority class in the database.

9. The method of claim 8 wherein the step of allocating resources comprises the sub-steps of:
determining transaction priority levels for the access terminals based on their respective priority classes; and
allocating the resources for transactions between the network and access terminals based on the transaction priority levels.

10. A method of communicating over a network with a wireless access terminal having at least one identifier, the method comprising the steps of:
determining at least one priority class for the access terminal based on the at least one identifier associated with the access terminal; and
allocating resources for transactions between the network and access terminal based on the at least one priority class.

11. The method of claim 10 further comprising the step of:
determining the at least one identifier from one or more communication protocol layers in place on the network.

12. The method of claim 10 wherein:
the network has forward and reverse communications links; and
the at least one priority class comprises at least first and second priority classes for transactions across the forward and reverse links, respectively, wherein the first and second priority classes may be the same or different.

13. The method of claim 10 wherein the step of allocating resources comprises the sub-steps of:
calculating at least one transaction priority level based on the at least one priority class; and
allocating the resources for transactions between the network and access terminal based on the at least one transaction priority level.

14. The method of claim 13 wherein:
the network has forward and reverse communications links; and
the at least one transaction priority level comprises at least a first transaction priority level for the forward link and a second transaction priority level for the reverse link, wherein the first and second transaction priority levels may be the same or different.

15. The method of claim 13 wherein:
the resources are allocated based on at least one allocation precedence rule as applied to the at least one transaction priority level.

16. The method of claim 13 wherein:
the method further comprises the step of receiving at least one requested priority from the access terminal; and
the resources are allocated based on the at least one requested priority and the at least one transaction priority level.

17. The method of claim 10 wherein:
the method further comprises the step of receiving at least one requested priority from the access terminal; and
the resources are allocated based on the at least one requested priority and the at least one priority class.

18. The method of claim 17 wherein:
the at least one requested priority is a function of an access terminal application in communication with the network.

19. A method of communicating with a wireless network comprising the steps of:
transmitting at least one requested transaction priority level to the wireless network; and
transmitting data to the wireless network according to communications resources allocated based on at least one assigned priority class and the at least one requested transaction priority level.

20. The method of claim 19 further comprising the step of:
transmitting a connection request message for initiating communications with the wireless network, wherein the at least one requested transaction priority level is contained in the connection request message.
